(19) United States
(12) Patent Application Publication
(10) Pub. No.: US 2017/0188021 A1
(43) Pub. Date: Jun. 29, 2017

(54) OPTICAL ENGINE FOR CREATING WIDE-FIELD OF VIEW FOVEA-BASED DISPLAY

(71) Applicant: Meta Company, San Matep, CA (US)

(72) Inventors: Raymond Chun Hing Lo, Richmond Hill (CA); Zhangyi Zhong, San Francisco, CA (US)

(73) Assignee: Meta Company, San Mateo, CA (US)

(21) Appl. No.: 15/390,422

(22) Filed: Dec. 23, 2016

Related U.S. Application Data
(60) Provisional application No. 62/387,217, filed on Dec. 24, 2015.

(51) Int. Cl. H04N 13/04; H04N 3/08; H04N 9/31

(52) U.S. Cl. CPC H04N 13/0497; H04N 13/044; H04N 9/3155; H04N 9/3161; H04N 9/3135; H04N 9/3164; H04N 3/08; H04N 13/0484

(57) ABSTRACT

Methods, systems, components, and techniques provide a retinal light scanning engine to write light corresponding to an image on the retina of a viewer. As described herein, a light source of the retinal light scanning engine forms a single point of light on the retina at any single, discrete moment in time. In one example, to form a complete image, the retinal light scanning engine uses a pattern to scan or write on the retina to provide light to millions of such points over one time segment corresponding to the image. The retinal light scanning engine changes the intensity and color of the points drawn by the pattern by simultaneously controlling the power of different light sources and movement of an optical scanner to display the desired content on the retina according to the pattern. In addition, the pattern may be optimized for writing an image on the retina. Moreover, multiple patterns may be used to additional increase or improve the field-of-view of the display. In one embodiment, these methods, systems, components, and technics are incorporated in an augmented reality or virtual reality display system.

### CROSS-REFERENCE TO RELATED APPLICATIONS

This application claims the benefit under 35 U.S.C. §119(e) of U.S. Provisional Application No. 62/387,217, titled “OPTICAL ENGINE WITH LASER SOURCE FOR CREATING WIDE-FIELD OF VIEW FOVEA-BASED AUGMENTED REALITY DISPLAY CROSS-REFERENCE TO RELATED APPLICATIONS” filed on Dec. 24, 2015 in the U.S. Patent and Trademark Office, which is herein expressly incorporated by reference in its entirety for all purposes.

### BACKGROUND

The interest in wearable technology has grown considerably over the last decade. For example, augmented reality (AR) displays that may be worn by a user to present the user with a synthetic image overlaying a direct view of the environment. In addition, wearable virtual reality (VR) displays present a virtual image to provide the user with a virtual environment. One example of such wearable technology is a stereoscopic vision system. The stereoscopic vision system typically includes a display component and optics working in combination to provide a user with the synthetic or virtual image.

### SUMMARY

Aspects of the disclosed apparatuses, methods and systems describe various methods, system, components, and techniques provide a retinal light scanning engine write light corresponding to an image on the retina of a viewer. As described herein, a light source of the retinal light scanning engine forms a single point of light on the retina at any single, discrete moment in time. To form a complete image, the retinal light scanning engine uses a pattern to scan or write on the retina to provide light to millions of such points over one time segment corresponding to the image. The retinal light scanning engine changes the intensity and color of the points drawn by the pattern by simultaneously controlling the power of different light sources and movement of an optical scanner to display the desired content on the retina according to the pattern . . . In addition, the pattern may be optimized for writing an image on the retina. Moreover, multiple patterns may be used to additional increase or improve the field-of-view (FOV) of the display. In one embodiment, these methods, systems, components, and technics are incorporated in an augmented reality or virtual reality display system.

In one aspect, a method for providing digital content in a virtual or augmented reality visual system is described. The method includes: controlling a light source to create a beam of light corresponding to points of an image; and moving an optical scanner receiving the beam of light from the light source to perform a scanning pattern to direct the light towards the retina of a viewer of the visual system; where the scanning pattern is synchronized over time with the points of the image provided by the beam to create a perception of the image by the viewer.

The light source may include one or more lasers.

The scanning pattern may be a spiral raster having a smaller gap between the lines of the spiral in the center of the spiral raster.

The optical scanner may direct a higher resolution scanning of the beam of light at the fovea of the retina.

The method may include reflecting the beam directed from the scanner by an optical element towards the eye of the viewer.

The method also may include adjusting the focus of the beam created by the light source to present the image at a particular depth of focus.

The optical scanner may include one or more microelectromechanical systems (MEMS) mirrors.

The combined operations of controlling and moving may be performed for each eye of the user.

In another aspect, a method for providing digital content in a virtual or augmented reality visual system is provided. The method includes: controlling a first light source to create a first beam of light corresponding to first points of an image; controlling a second light source to create a second beam of light corresponding to second points of the image; and moving a first optical scanner receiving to the first beam light from the first light source according to a first scanning pattern to direct the light of the first beam towards the retina of a viewer of the visual system; and moving a second optical scanner receiving to the second beam light from the second light source according to a second scanning pattern to direct the light of the second beam towards the retina of a viewer of the visual system; wherein the first scanning pattern and the second scanning pattern are synchronized over time with the points of the image provided by the first and second beams to create a coherent perception of the image by the viewer.

The first and second light sources may include one or more lasers.

The diameter of the beam created by the first light source may be smaller than the diameter of the beam created by the second light source.

The first scanning pattern may be a first spiral raster directing the first beam of light towards the fovea region of the retina of the viewer, and the second scanning pattern may be a second spiral raster directing the second beam of light towards a region outside of the fovea of the retina of the viewer.

The optical scanner may directs a higher resolution scanning of the beam of light at the fovea of the retina.

The first spiral raster and the second spiral raster may partially overlap.

The method also may include reflecting the first beam directed from the first scanner and the second beam directed from the second scanner by an optical element towards the eye of the viewer.

The method also may include adjusting the focus of at least one of the first beam and the second beam to present the image at a particular depth of focus.

The first scanner and the second scanner each may include one or more microelectromechanical systems (MEMS) mirrors.

The combined operations controlling the first and second light sources and moving the first and second optical scanner may be performed for each eye of the user.

In yet another aspect, a retinal display system comprises: at least one retinal light scanning engine, the retinal scanning engine includes: a light source configured to create a beam of light corresponding to points of an image; and an optical scanner coupled to the light source and configured to receive the beam of light from the light source and perform a scanning pattern; where the scanning pattern synchronizes movement of the optical scanner over time with the points of the image provided by the beam to direct light of the beam towards the retina of a viewer of the display system and create a perception of the image by the viewer.

The display also may include at least one processing device configured to execute instructions that cause the processing device to control the at least one retinal light scanning engine by providing control signals to the light source and the scanning pattern to the optical scanner.

The light source may include one or more lasers.

The scanning pattern is spiral raster may have a smaller gap between the line of the spiral in the center of the spiral raster and the optical scanner directs a higher resolution scanning of the beam of light at the fovea of the retina.

The display also may include an optical element corresponding to the at least one retinal light scanning engine and configured relative to the optical scanner and eyes of the viewer of the system to reflect the beam directed from the scanner by towards the eye of the viewer.

The at least one retinal light scanning engine also may include an adjustable focal element positioned between the light source and the scanner that is configured to focus of the beam created by the light source to present the image at a particular depth of focus.

The scanner may include one or more microelectromechanical systems (MEMS) mirrors.

The display also may include at least one other retinal light scanning engine wherein the at least one retinal light scanning engine and the at least one other retinal light scanning engine are configured to create separate beams of light for each eye of a viewer of the display.

The display also may include at least one other retinal light scanning engine wherein the at least one other retinal light scanning engine includes: at least one other light source configured to create another beam of light corresponding to points of the image; at least one other optical scanner optically coupled to the at least one other light source and configured to receive the at least one other beam light from the at least one other light source and move according to another scanning pattern; wherein the scanning pattern synchronizes movement of the optical scanner over time with the points of the image provided by the beam to direct light of the beam towards the fovea of the retina of a viewer of the display system, and the other scanning pattern synchronizes movement of the other optical scanner over time with the points of the image provided by the other beam to direct light of the other beam towards a region of retina outside the fovea of a viewer of the display system to create a coherent perception of the image by the viewer.

The at least one other light source may include one or more lasers.

The diameter of the beam created by the light source may be smaller than the diameter of the beam created by the at least one other light source.

The scanning pattern and the at least one other scanning pattern may be a first spiral and a second spiral raster, and the gap between the spiral line of the first spiral may be greater than the gap between the spiral line of the second spiral raster.

The scanning pattern and the at least one other scanning pattern may be a first spiral and a second spiral raster, and the first spiral raster and the second spiral raster may partially overlap. The details of various embodiments are set forth in the accompanying drawings and the description below. Other features and advantages will be apparent from the following description, the drawings, and the claims.

### DETAILED DESCRIPTION:

The following description illustrates aspects of embodiments of the disclosed apparatuses, methods, and systems in more detail, by way of examples that are intended to be non-limiting and illustrative with reference to the accompanying drawings, in which:

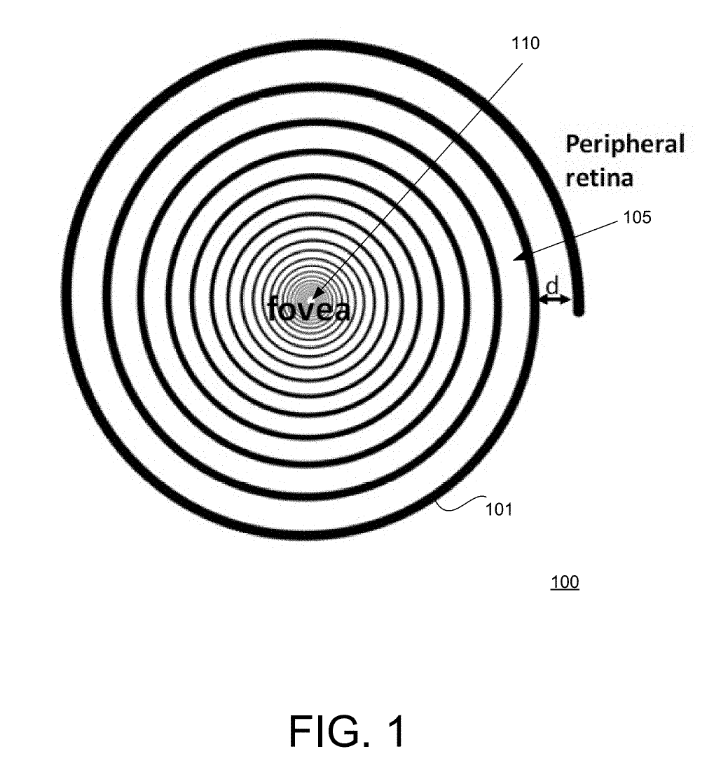

FIG. 1 shows an example of a scanning pattern that may be provided by scanning light engine of a retinal display device to write content to the retina of a viewer;

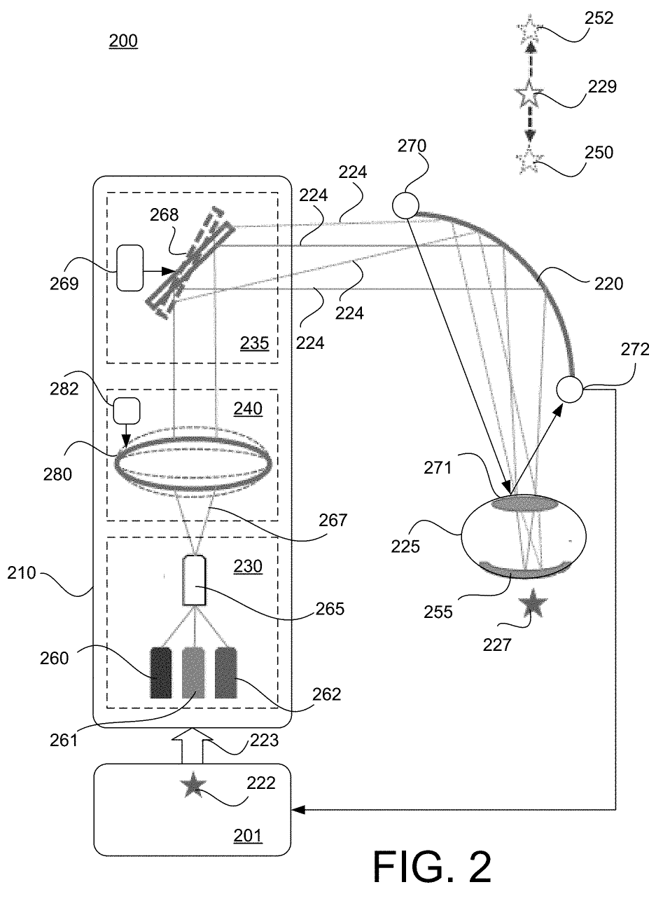

FIG. 2 shows one example of a configuration of the retinal display system;

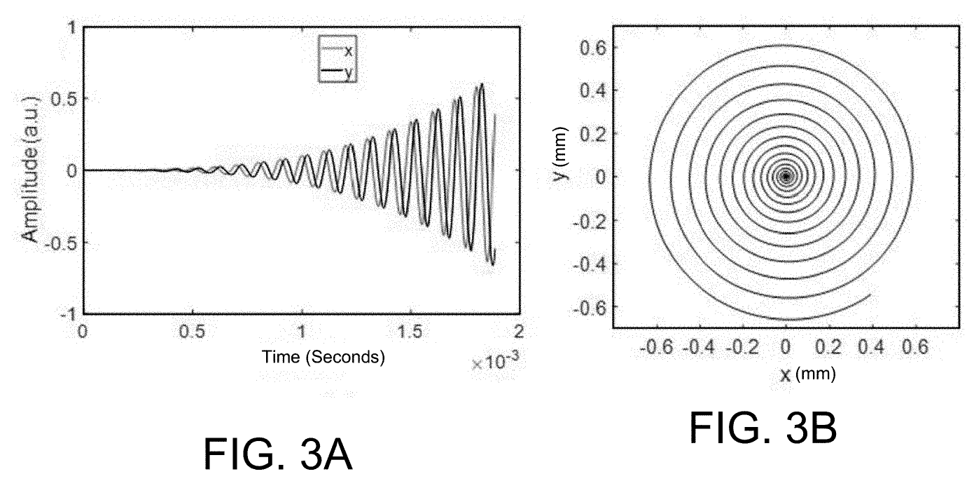

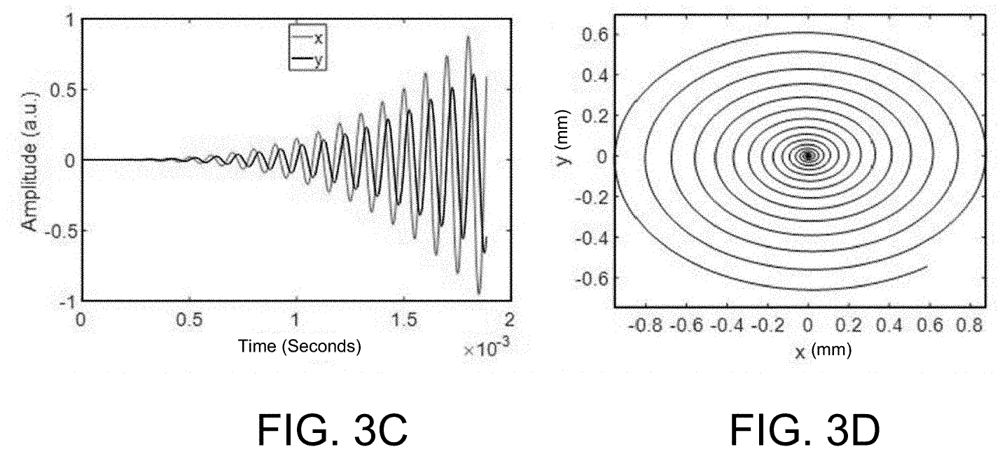

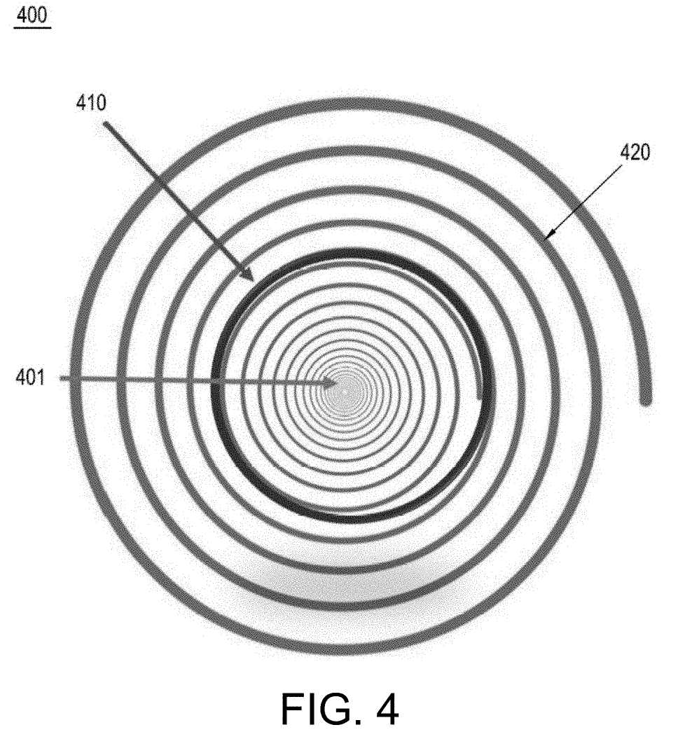

FIG. 3A shows an example of amplitude modulated control signals for a retinal scanning device of a scanning light engine;

FIG. 3B shows an example of a spiral raster scanning pattern of the scanning light engine of a retinal display device generated by the control signals shown in FIG. 3A;

FIG. 3C shows an example of amplitude modulated control signals for a retinal scanning device of a scanning light engine;

FIG. 3D shows an example of a spiral raster scanning pattern of the scanning light engine of a retinal display device generated by the control signals shown in FIG. 3C;

FIG. 4 shows an example of the tiling of multiple scanning rasters to increase the total FOV provided by a retinal display system;

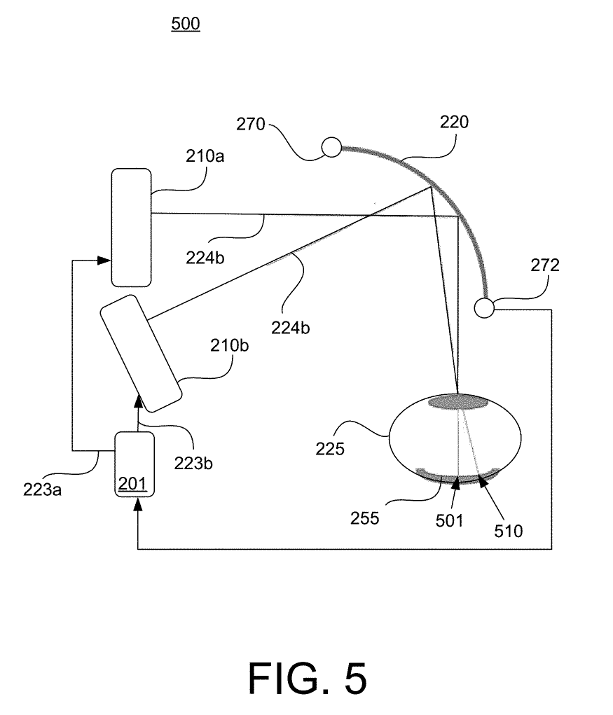

FIG. 5 shows another example of a configuration of the retinal display system with multiple scanning light engines;

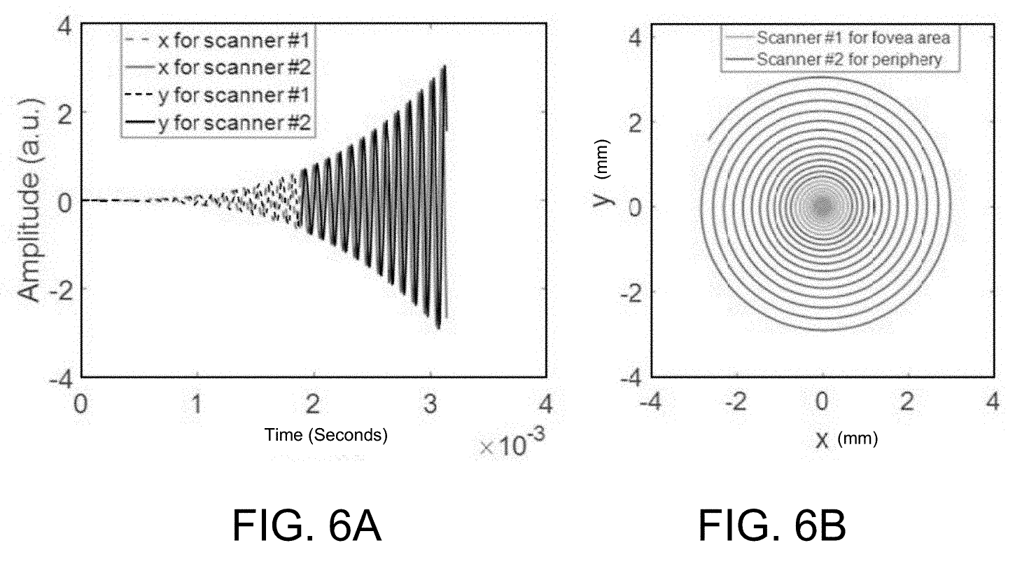

FIG. 6A shows an example of the amplitude modulated control signals for the multiple scanning light engines of the retinal scanning device of FIG. 5;

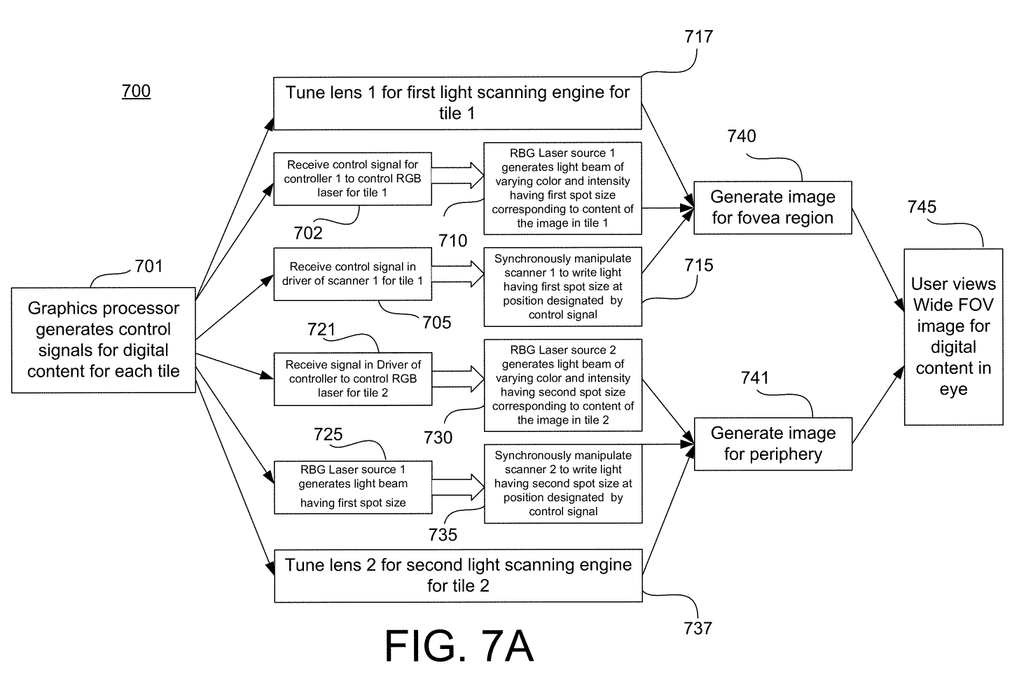

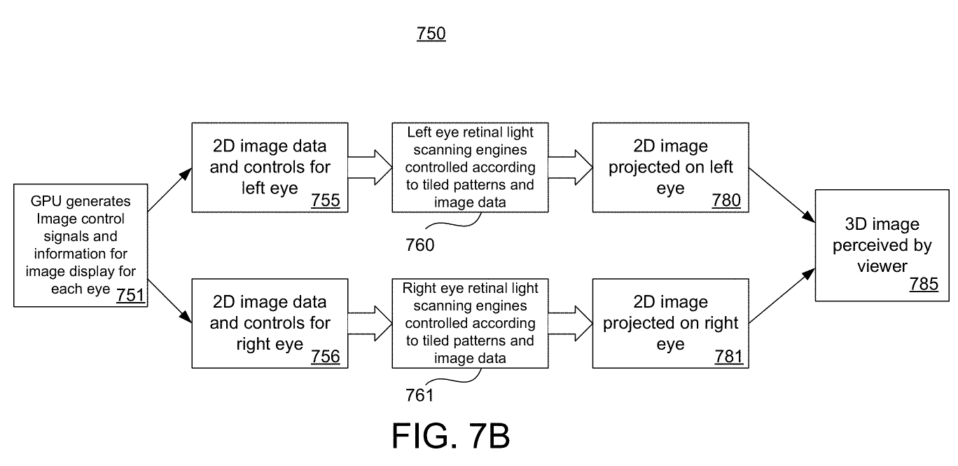

FIG. 6B shows an example of the spiral raster patterns provided by the retinal scanning device for the control signals shown in FIG. 6A to write content to the retina; FIG. 7A shows a flow chart of an exemplary process for controlling the retinal display system of FIG. 5;

FIG. 7B shows a flow chart of an exemplary stereoscopy process for controlling the retinal display system of FIG. 5; and

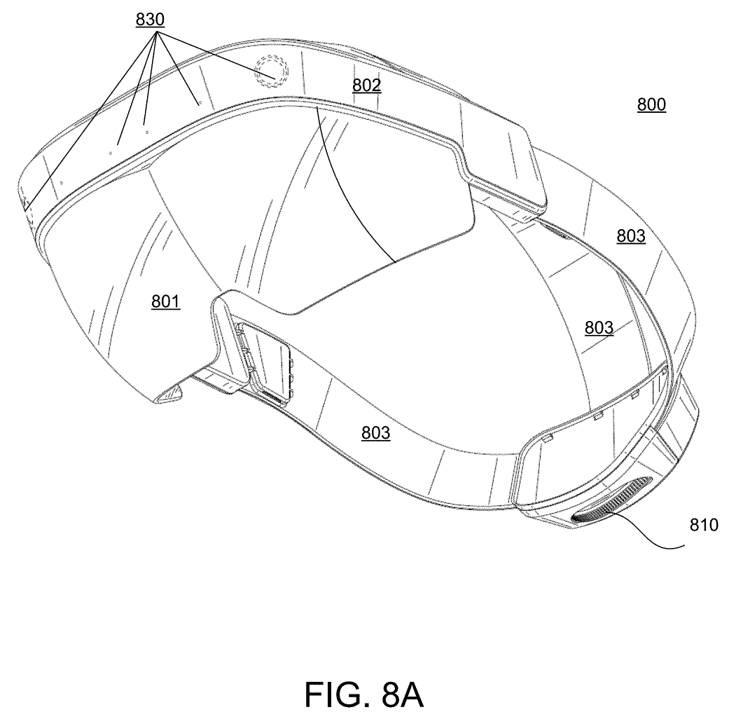

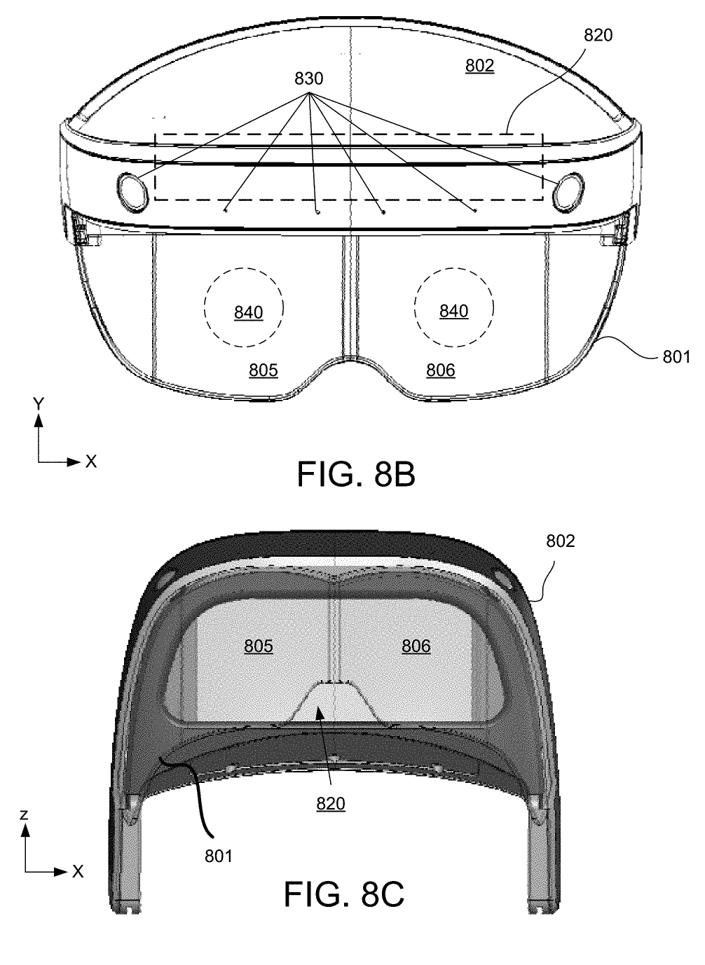

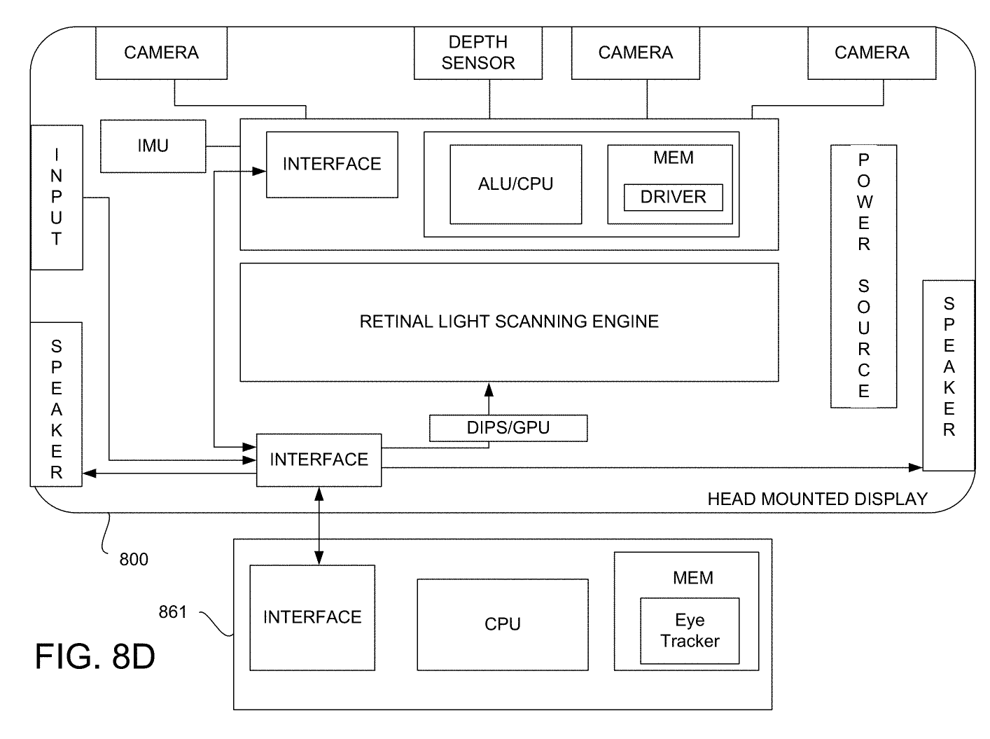

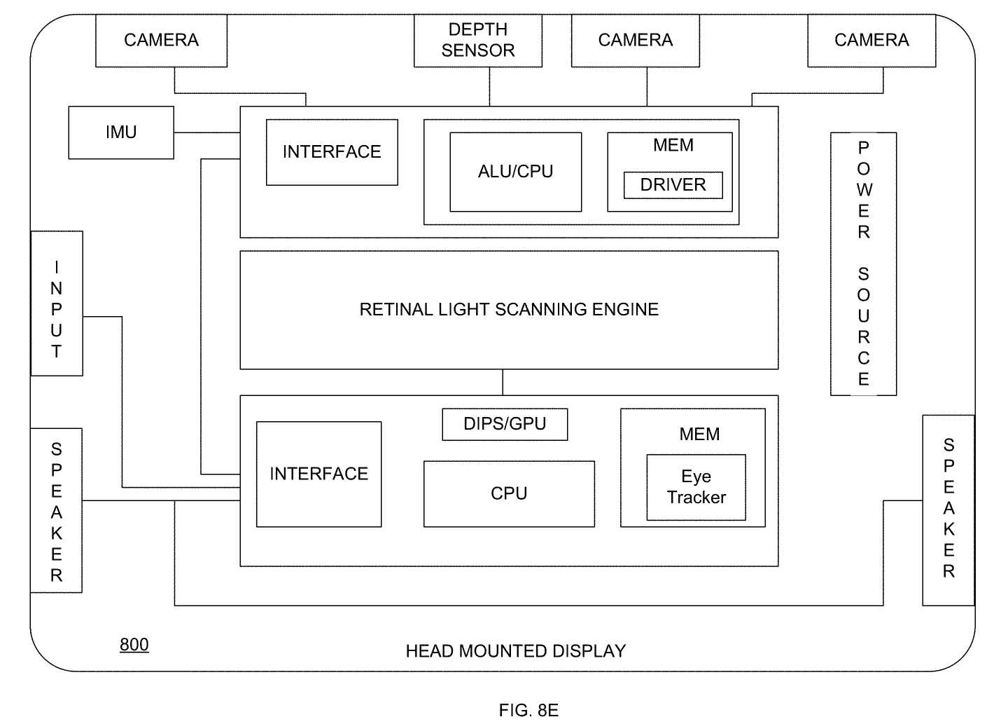

FIGS. 8A, 8B, 8C, 8D, and 8E show examples of a head mounted display with a retinal display system.

### DETAILED DESCRIPTION

The following detailed description is merely exemplary in nature and is not intended to limit the described embodiments (examples, options, etc.) or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable making or using the embodiments of the disclosure and are not intended to limit the scope of the disclosure. For purposes of the description herein, the terms “upper,” “lower,” “left,” “rear,” “right,” “front,” “vertical,” “horizontal,” and similar terms or derivatives thereof shall relate to the examples as oriented in the drawings and do not necessarily reflect real-world orientations unless specifically indicated. Furthermore, there is no intention to be bound by any expressed or implied theory presented in the following detailed description. It is also to be understood that the specific devices, arrangements, configurations, and processes illustrated in the attached drawings, and described in the following specification, are exemplary embodiments (examples), aspects and/or concepts. Hence, specific dimensions and other physical characteristics relating to the embodiments disclosed herein are not to be considered as limiting, except in the context of any claims, which expressly state otherwise. It is understood that “at least one” is equivalent to “a.”

The aspects (examples, alterations, modifications, options, variations, embodiments, and any equivalent thereof) are described with reference to the drawings; it should be understood that the descriptions herein show by way of illustration various embodiments in which claimed inventions may be practiced and are not exhaustive or exclusive. They are presented only to assist in understanding and teach the claimed principles. It should be understood that they are not necessarily representative of all claimed inventions. As such, certain aspects of the disclosure have not been discussed herein. That alternate embodiments may not have been presented for a specific portion of the invention or that further alternate embodiments, which are not described, may be available for a portion is not to be considered a disclaimer of those alternate embodiments. It will be appreciated that many of those embodiments not described incorporate the same principles of the invention and others that are equivalent. Thus, it is to be understood that other embodiments may be utilized and functional, logical, organizational, structural and/or topological modifications may be made without departing from the scope and/or spirit of the disclosure.

The interest in wearable technology has grown considerably over the last decade. For example, wearable augmented reality (AR) displays present the user with a synthetic image overlaying a direct view of their real world environment. In addition, wearable virtual reality (VR) displays present a virtual image to immerse a user in a virtual environment. The following description pertains to the field of wearable display system and particularly to wearable AR and VR wearable devices, such as a head mounted display (HMD). For example, binocular or stereoscopic wearable AR and VR devices are described herein with an enhanced display devices optimized for wearable AR and VR devices. In various examples, the wearable AR and VR devices described herein include a new, enhanced retinal digital display device.

Point based light sources, such as lasers, are one source of illumination that may be used to illuminate the retina. However, use of a point based light source in an HMD has problems when used to illuminate a retina. For example, a point based light system is only cable of illuminating a single point at any discrete moment in time. Therefore, in order to use a point based light source to display an image, either many point based light sources must be used or the point based light source must be moved over time. For example, in order to create a detailed image by illuminating the retina with a point based light system, an enormous number of light sources would be needed. However, a display system with many point based light sources would be costly and power prohibitive, difficult to control, and heavy or unwieldy for a viewer to wear in an HMD implementation. Alternatively, moving a single point based light source is difficult to control and form a clear image. In addition, hardware needed to move the light source would also be costly and unwieldy when implemented in an HMD.

In order to overcome these and other problems, a retinal light scanning engine is provided to write light corresponding to an image on the retina of a viewer. As described herein, the light source of the retinal light scanning engine forms a single point of light on the retina at any single, discrete moment in time. To form a complete image, the retinal light scanning engine uses a pattern to scan or write on the retina to provide light to millions of such points over one time segment corresponding to the image. The retinal light scanning engine changes the intensity and color of the points drawn by the pattern by simultaneously controlling the power of different light sources to display the desired content on the retina. In addition, the pattern may be optimized for writing an image on the retina. Moreover, multiple patterns may be used to additional increase or improve the field-of-view (FOV) of the display.

As noted herein, different areas of the retina have different attributes or properties affecting vision. For example, according to the various embodiments and examples provided herein, it is established that the cone photoreceptors of the eye are packed with higher density at the fovea region of the retina, as compared to the periphery of the retina (See, e.g., Osterberg G. Topography of the layer of rods and cones in the human retina. Acta Ophthal Suppl. 6, 1-103 (1935). The light scanning engine uses a scanning pattern that provides a denser scanning near the fovea. For example, the scanning pattern writes light more densely to the fovea region in order to provide the finer details of displayed digital content. In another example, the FOV of a retinal display is increased by using multiple light scanning engines, each with different scanning patterns, to tile different portions of an image projected onto the eye of a user. For example, one image-scanning pattern may be used to write a portion of the image to the fovea, and a second to image scanning pattern may be used to write the remaining portion of the image to the remaining area of the retina. Each tiled portion of the image is generated by the corresponding scanning light engine. In one example, a light scanning engine uses a light source with a smaller spot size for scanning the fovea region of the retina than a light source of a light scanning engine scanning other areas of the retina. In one example, because the fovea contains a higher concentration of cone receptors than other regions of the human eye, the resolution or spot size of a light source decreases the further away from the fovea the light source is scanning. By tiling multiple images or portions of an image onto the eye of a viewer, the field-of-view (FOV) of the light scanning engine is increased.

In another example, the retinal display system may include an eye tracking system. The eye tracking system may be used to determine where the focus of the viewer is at any one movement. For example, the eye tracking system may determine the direction or line of sight of a viewer and extrapolate an area or depth of focus within in an image, such as an object of interest. The retinal display system provides visual accommodation of rendering an image by providing focal adjustment of the image based on the surmised area or depth of focus.

FIG. 1 shows an example of a scanning pattern 100 that may be provided by scanning light engine of a retinal display device. Light from a source is directed into the retina of a viewer, which is perceived as a corresponding image by the viewer. The light is directed into the retina according to a corresponding scanning pattern. In one example, the scanning pattern is designed corresponding to the decrease in cone photoreceptor density of the retina as the distance of the line drawn according to the scanning pattern from the fovea increases. For example, a spiral pattern or spiral raster may be used to draw the image on the retina of a user. As shown in FIG. 1, the gap d between the lines 101 drawn according to the scanning pattern 100 becomes larger as the spiral raster moves towards the retina periphery 105. Therefore, the pattern is denser at the center region 110 corresponding to the fovea of the retina. As a result, the retinal display provides greater resolution for the fovea area of the retina. FIG. 1 shows on possible scanning pattern; however, other scanning patterns are possible. For example, the rate of increase of the distance d may vary between patterns. In addition, other types and/or number of patterns may be used to draw a corresponding image on the retina, some examples of which are described in further detail below.

FIG. 2 shows a side view of one example of a configuration of the retinal display system 200. As shown in FIG. 2, the retinal display system 200 includes a digital image processing system 201, a retinal light scanning engine 210, and an optical element 220. The digital image processing system 201 processes digital content corresponding to an image 222 that is to be displayed by the retinal display system 200. The digital image processing system 201 provides information and control signals 223 corresponding to the image 222 to the retinal light scanning engine 210. The retinal light scanning engine 210 writes light 224 corresponding to the image 222 to the eye 225 of the viewer of the retinal display system 200 via the optical element 220 where the image 227 is perceived by the viewer as a virtual or synthetic image 229 within the FOV of the viewer. The retinal light scanning engine 210 includes a light source 230 and an optical scanning device 235.

In addition, in one or more examples, the retinal light scanning engine 210 includes a multifocal optical element 240, and the retinal display system 200 includes an eye tracking system. The eye tracking system provides an indication to the system of the focus of the viewer, which may be then used to vary the focal depth of the image 229 (e.g., between a near plane of focus 250 and/or a far plane of focus 252).

For simplicity and conciseness of explanation, only one retinal light scanning engine 210 and eye 225 are shown in FIG. 2. However, one skilled in the art will appreciate that a stereoscopic or binocular retinal display system 200 includes at least one light scanning engine 210 for each eye 225 of the user.

The digital image content source 201 provides digital content, such as an image 222 for viewing by the user of the retina display system 200. The digital image processing system 201 may include one or more processing devices and memory devices in addition to various interfaces with corresponding inputs and outputs to provide information and signals to and from the processing and memory devices. In one example, the digital image processing system 201 may include or be implemented using a digital graphics processing unit (GPU). The digital image processing system 201 controls the retinal light scanning engine 210 to write an image to the retina of the viewer. In particular, the digital image processing system 201 controls the light source 230 and the optical scanning device 235 to write light according to one or more scanning patterns or scanning rasters to the retina 255 of a viewer of the retina display system 200. In order to form a perceived image 229, the control of the optical scanning device 235 and the power of different elements of the light source 230 are synchronized to write light corresponding to the image 222 to the retina of the user. The image is segmented into strips that correspond to a scanning or raster pattern. The digital image processing system 201 generates information and control signals 223 for each pixel of the image by synchronizing a corresponding brightness and/or color generated by the light source 230 with the scanning pattern used to control the optical scanning device 235. As a result, the retinal display system is a point-based, time sequential display system. The control of the various components of the system is described in further detail below. In one example, the frame rate of images written by the optical scanning device is greater than or equal to 60 Hz.

The light source 230 is controlled by the digital image processing system 201 to provide light corresponding to an image 227 to be drawn on the retina 255. In one embodiment, the light source 230 may incorporate multiple lasers. For example, multiple lasers, such as a red laser 260, a green laser 261, and a blue laser 262 are combined to construct an RGB laser. In order to combine the multiple laser sources 260, 261, and 262, the light source 230 also may include a combiner 265, for example, a fiber wavelength-division multiplexing (WDM) coupler or other combining mechanism to combine the light from the multiple lasers to form a RGB beam light source 267. In one example, the RGB laser beams are spatially overlapped in a multiplexing combiner, and the overlapped RGB laser beams are coupled into a fiber. In another example, a dichroic laser beam combiner may be used to combine the beams. For example, the coating material and thickness of the combiner are selected such that a laser beam with certain wavelength is reflected and laser beams with other wavelengths are transmitted. In another example, a dichroic laser beam combiner can combine two RGB laser beams into a single beam. The light source 230 also includes an input and drivers that receive the control signals from the digital image processing system 201. The control signals change the intensity and color of a corresponding pixel of the image by simultaneously controlling the power of different light sources 260, 261, and 262 corresponding to the desired content to be displayed on the retina.

In one example, the light source 230 is fiber coupled red (R), green (G), and blue (B) pigtailed laser diodes. The power of the laser can be controlled by the current applied to the laser diode. For example, the power of the laser may be on the order of 1-10mW. The laser can be switched on/off at a frequency above 1 MHz. In addition, the laser may be chosen to match attributes of the retina being written to. For example, a laser writing to the fovea region of the retina may be chosen to have a smaller spot size than a laser writing to a peripheral portion of the retina. In one example, the laser beam may have a diameter of substantially 0.5 mm to approximately 1 mm depending on the area of the retina written to (as explained in further detail below).

In one exemplary embodiment, an optical scanning device 235 draws the light of the beam 267 from the light source 230 in lines, patterns, and/or the like, such as, for example, a scanning raster, on different regions of the retina 255 based on sensitivity and acuity of the corresponding region of the retina 255. The optical scanning device 235 includes a number of electrically driven, mechanically movable components. In one example, the optical scanning device includes a deformable, reflective component 268 controlled by a corresponding controller 269 to write light from the light source 230 in a desired pattern. In one example, the deformable reflective component 268 of the optical scanning device can be a single mirror with two-dimensional (2D) movement; or two mirrors where each mirror corresponds to a different orthogonal dimension of movement. For example, the deformable reflector/mirror may be implemented using a dual axis microelectromechanical systems (MEMS) mirror, or two single-axis MEMS mirrors.

In another example, the deformable component 268 also can be implemented using a 2D mechanically movable component, such as, for example, a piezoelectric scanner tube or a voice coil actuator in combination with a fiber light source. For example, a piezoelectric tube scanner is a 2D scanner comprising a thin cylinder of radially poled piezoelectric material with four quadrat electrodes. A control voltage may be applied to any one of the external electrodes to expand the tube wall resulting in a lateral deflection of the tube tip. The fiber combiner of the light source is bonded at the center of the tube. By controlling the deflection, the controller 269 cause the tip to write light in the desired pattern.

In another example, a voice coil actuator provides a linear motion, high acceleration, and high frequency oscillation device, which utilizes a permanent magnet field and coil winding (e.g., a conductor) to produce a force that is proportional to the current applied to the coil. In this example, the light from the fiber combiner is positioned on two orthogonal bonded voice coil actuators. In the case, one voice coil actuator is used to scan in the x dimension while a second voice coil actuator, placed orthogonally adjacent to the first voice coil actuator, is used to scans in the y direction. The controller 269 causes a current to be applied to the coils to write light in the desired pattern.

The reflective component 268 is coupled to a controller 269 consisting of driving circuitry that controls the movement of the reflective component 268 in two dimensions to write light from the light source 230. In one example, the reflective component 268 uses a spiral-based movement corresponding to the scanning pattern. For example, a dual axis MEMS mirror is moved in a circular/spiral motion by inducing a sine-wave controlled signal to the MEMS mirror driver circuits to control each axis of movement. In this example, the circular/spiral motion is induced on the mirror by synchronizing the sine-wave control signal on each axis of movement. The size of the circle created by the motion is controlled by varying the amplitude of the signal on each axis, and the gap g between lines of the spiral is controlled by the frequency. In one embodiment, the MEMS mirror is controlled based on frequency and amplitude, for example, using an alternating current (AC) generator.

In one embodiment, movement of the reflective component 268 (e.g., the MEMs mirror) is synchronized with the content provided by the light source 230 under control of the digital image processing system 201. The digital image processing system 201 buffers a rasterized image corresponding to a scanning raster, for example, an image is segmented into circular strips corresponding to a circular/spiral scanning raster. Traditionally, digital images are segmented into lines and columns (e.g., according to a Cartesian coordinate system). However, in this and other exemplary embodiments described herein using a circular/spiral raster scanning pattern, the rasterized image is segmented into circular strips (e.g., using a polar coordinate system). In one example, conversion between a traditional Cartesian coordinate system (x,y) and polar coordinate (r,θ) may be performed according to:

x=r×cos(θ)

y=r×sin(θ)

in order to segment the image into circular strips corresponding to the circular/spiral raster scanning pattern.

The digital image processing system 201 controls the light of the RGB laser over time corresponding to the data for color and intensity for the image in a strip. The digital image processing system 201 also controls the MEMs mirror via the scanning raster to synchronize the movement of the mirror in time with a corresponding point of light matching a desired pixel of the spiral image strip to project the point of light onto the desired point of the retina 255 (via the optical element 220).

In one or more exemplary embodiments, the retinal light scanning engine 210 may include a multifocal optical element 240 and the retinal display system includes a corresponding eye tracking system. In one example, the eye tracking system includes binocular eye tracking components. For example, the architecture of the eye tracking system includes at least two light sources 270 (one per each eye 225), such as, for example, one or more infrared (IR) LED light sources. The light sources 270 are positioned or configured to direct IR light into the cornea and/or pupil 271 of each eye 225. In addition, at least two sensors 272 (e.g., one per each eye 225), such as, for example, an IR camera are positioned or configured to sense the positioning or line of sight of each eye 225. For example, the IR cameras are configured to read the IR reflectance from a corresponding eye. Data corresponding to the determined reflectance is provided to the digital image processing system 201 (or other processing component) and processed to determine the pupil and corneal reflectance position. In one example, both the source and the sensors may be mounted to a frame or housing of the retinal display system.

In one example, the digital image processing system 201 includes an associated memory storing one or more applications (not shown) implemented by the digital image processing system 201. For example, one application is an eye tracking application that determines the position of the pupil, which moves with the eye relative to the locus of reflectance of the IR LED source, and maps the gaze position or line of site (LOS) of the viewer in relation to the graphics or scene presented by the retinal display system 200. In one example, an application implemented by the digital image processing system 201 integrates the output received from each sensor 272 to compute three-dimensional (3D) coordinates of the viewer's gaze. The coordinates are used by digital image processing system 201 to adjust focus of the multifocal optical element 240. A number of different methods for adjusting focus using multifocal optical elements are described in further detail below. In the case where an IR source and tracker are used, the optical element 220 should reflect IR light.

In one embodiment, the focal distance of the retinal display system 200 may be adjusted by the multifocal optical element 240, such as a variable power or tunable focus optical device 280 and corresponding electrical/mechanical control devices 282. The multifocal optical element 240 is positioned in the path of the beam of light between the light source 230 and the optical scanning device 235. In one example, a variable power optical lens or a group of two or more such lenses may be used. The variable power lens, or tunable focus optical lens, is a lens, which the focal length is changeable according to an electronic control signal. In one example, the variable power lens may be implemented using a liquid lens, a zoom lens, or a deformable mirror (DM). For example, a deformable mirror is a reflective type tunable lens that can be used to tune the focal plane. In the case of a liquid lens, the lens may include a piezoelectric membrane to control optical curvature of the lens, such as by increasing or decreasing the liquid volume in the lens chamber. A driving voltage for the membrane is determined by the digital image processing system 201 based on the output from the eye tracker application to tune the focal plane.

In general, by controlling the focus of the variable power or tunable optical lens or group of lenses, the optical path of the light from the retinal light scanning engine 210 entering the eye 225 is changed. As a result, the lens 271 of the eye 225 responds and changes in power accordingly to focus the digital content projected onto the retina 255. In this manner, perceived location of the virtual image 229 within the projected light field may be moved in relation to the combiner 220. By increasing the power of the lens, convergence of the beam of light entering the eye 225 also is increased. In this case, the lens 271 of the eye 225 requires less power to focus the light on the retina 255, and the eye 225 is more relaxed. The resulting virtual image 229 is perceived as being located at a further distance to the user (e.g., closer to the far focal plane 252). Conversely, by decreasing the power of the lens, convergence of the beam of light entering also is decreased. In this case, the lens 271 of the eye 225 requires more power to focus the light on the retina 255, and the eye 225 is better accommodated. The resulting virtual image 229 is perceived as being located at a closer distance to the user (e.g., closer to the near focal plane 250).

For example, the IR light source may be configured within the retinal display system to direct light at each of the eyes of a viewer. In one embodiment, the IR light source may be configured in relation to the frame or housing of an HMD to direct light from the source at the cornea/pupil area of the viewer's eyes. Reflectance of the light source is sensed from the left and right eyes, and the eye position of each eye is determined. For example, one or more IR sensors may be positioned to sense the reflectance from the cornea and pupil of each eye. In one implementation, an IR camera may be mounted to a frame or housing of an HMD configured to read the reflectance of the IR source from each eye. The camera senses the reflectance, which is processed to determine a cornea and/or pupil position for each eye. The convergence point of the viewer is determined. For example, the output from the IR cameras may be input to a processing device. The processing device integrates the eye positions (e.g., the cornea and/or pupil position for each eye) to determine a coordinate (e.g., a position in 3D space denoted, e.g., by x, y, z coordinates) associated with the convergence point (CP) of the viewer's vision. In one embodiment, the CP coincides with an OOI that the user is viewing at that time. In one example, system determines the coordinate of the pixel that the eye is fixated on, fixation coordinate (FC), from the output of the eye tracker. The coordinate is used to look up the depth information from corresponding to an image presented by the retinal display system. For example, when a digital image processing system 201 renders the image to a frame buffer and the depth data to a separate depth or z-buffer, the depth information may be read from the buffer. The retrieved depth information may be a single pixel or aggregate of pixels around the FC. The depth information is then used to determine the focal distance.

In another example, the FC is used to cast a ray into the virtual scene. In one implementation, the first object that is intersected by the ray may be determined to be the virtual OOI. The distance of the intersection point of the ray with the virtual OOI from the viewer is used to determine the focal distance. In another example, the FC is used to cast a ray into the virtual scene as perceived for each eye. The intersection point of the rays is determined as the CP of the eyes. The distance of the intersection point from the viewer is used to determine a focal plane. The retina display system uses the determined CP to adjust the focal plane to match the CP. For example, coordinates of the CP are converted into a corresponding control signal provided to the multi focal optical element, for example, to change the shape of the lens to coincide focus of the lens with the coordinates. In another example, progressive multifocal lenses are dynamically moved to re-center the focal plane to coincide with the determined coordinates.

The light 224 from the retinal light scanning engine 210 providing the digital content is directed to the eye 225 of a viewer by an optical element 220. In a VR application, the optical element is a reflective surface, which reflects substantially all of the light 224 to the corresponding eye 225 of the viewer without allowing any exterior light from the user's environment to pass through the optical element 220. In an AR application, the optical element 220 a partial-reflective-partial-transmissive optical element (e.g., an optical combiner). A portion of the light 224 is reflected by the optical element 220 to form an image of the content on the retina 255 of the viewer. As a result, the viewer perceives a virtual or synthetic light field overlaying the user's environment. The optical component 220 may be provided in various shapes and configurations, such as a single visor or as glasses with an associated frame or holding device.

In one example, the optical element 220 is implemented as a visor with two central image areas. An image area is provided for each eye having a shape, power, and/or prescription that combined with one or more reflective coatings incorporated thereon, reflect light 224 corresponding to an image from the retinal light scanning engine 210 to the eyes 225 of the user. In one example, the coating is partially reflective allowing light to pass through the visor to the viewer and thus create a synthetic image in the field of view of the user overlaid on the user's environment and provide an augmented reality user interface. The visor can be made from a variety of materials, including, but not limited to, acrylic, polycarbonate, PMMA, plastic, glass, and/or the like and can be thermoformed, single diamond turned, injection molded, and/or the like to position the optical elements relative to an image source and eyes of the user and facilitate attachment to the housing of an HMD. In one example, an optical coating for the eye image regions is selected for spectral reflectivity for the concave side. In this example, the dielectric coating is partially reflective (e.g., ˜30%) for visible light (e.g., 400-700 nm) and more reflective (e.g., 85%) for IR wavelengths. This allows for virtual image creation, the ability to see the outside world, and reflectance of the IR LED portion of the embedded eye tracking system (all from the same series of films used for the coating).

In another example, the optical element 220 can be also implemented as a planar grating waveguide. The waveguide has a grating couple-in portion and a grating output presentation portion. The light from the retinal light scanning engine is coupled into the waveguide though the grating couple-in portion, and then propagated to the grating output presentation by total internal reflection. Finally, the light is decoupled and redirected toward the viewer's eye at the grating output presentation portion of the planar grating waveguide.

In another example, the optical element 220 can be also implemented as a planar partial mirror array waveguide. In this example, the light from the retinal light scanning engine is coupled into the waveguide at the entrance of the waveguide, and propagated to the partial mirror array region of the waveguide by total internal reflection. The light is reflected by the partial mirror array and directed toward the viewer's eye.

FIG. 3A shows an example of amplitude modulated control signals for a retinal scanning device 235 of a scanning light engine 210. FIG. 3B shows an example of a spiral raster scanning pattern of the scanning light engine of a retinal display device generated by the control signals shown in FIG. 3A. As described above, a sinusoidal voltage may be input to the controller of the retinal scanning device 235 to form a spiral raster pattern of light on the retina. By using such a pattern, the efficiency and speed at which digital content may be provided by the retinal display system can be increased and/or optimized.

For example, in one or more of the embodiments herein, the retinal-scanning device may be implemented using a dual axis MEMS mirror. In this example, the MEMS mirror may be moved in a circular motion by, in one embodiment, by inducing a sine-wave controlled signal to the MEMS mirror driver circuits on each axis of movement.

In one example, the spiral raster may be formed by the scanner controlled according to equation [1] as:

x(t)=a*t̂b*cos(c*t) [1]

y(t)=d*t̂e*sin(c*t)

where a,d are the length and width of the spiral, respectively, b and e are the separate speed between the spiral in the orthogonal axes, c is the angular frequency, t is a time variable, which ranges from 0 to one frame time as the spiral moves, and x(t),y(t) denote the time dependent location of the scanning spiral raster.

In this example, by synchronizing the sine wave on each and x and y axis a circular/spiral motion is induced on the mirror. The size of the circle created by the motion may be controlled by the amplitude of the signal in each axis. In one embodiment, the dual axis MEMS mirror may be controlled based on frequency and amplitude, for example, using an alternating current (AC) generator, as shown in FIG. 3A. In this manner, the dual axis MEMs mirror may be controlled to write content to the retina using a corresponding spiral raster pattern, for example, as shown in FIG. 3B.

Other scanning raster patterns also may be used to control the retinal scanning device. For example, an elliptical spiral as shown in FIGS. 3C and 3D can be used. In another example, a non-spiral raster pattern may be used. For example, using two single axis MEM mirrors, the linear motion of each mirror on different orthogonal axes may be controlled. In this example, one mirror on a first axis responds for a fast horizontal line scan, and the second MEMS mirror on the other axis responds for the slow vertical line scan. Together, the two MEMS mirrors scan covers a rectangular scanning area. However, such a scanning area does provide some of the advantages regarding the fovea regions as the spiral raster.

FIG. 4 shows an example 400 of tiling of multiple scanning rasters to increase the total FOV of a retinal vision system. In one embodiment, different light scanning engines each scanning with different spiral raster patterns are used to tile images or portions of the image onto the retina. Each scanner includes a spiral raster that writes light at different eccentricity degrees on the retina. For example, one light scanning engine use a spiral raster to scan light near the fovea region, while one or more other light scanning engines scan light at more peripheral areas of the retina. In one example, the scanner active near the fovea region scans with a smaller spot size. In this case, the gap d between the scanning curves is denser matching the higher density of packed cone photoreceptors of this region. In addition, the peripheral scanners have a bigger scanning spot size. In this case, the scanning curves are calibrated to occur farther apart to match the lower photoreceptor density and cover a bigger retinal area.

As shown in FIG. 4, two spiral rasters 401 and 420 are used to write light on the retina. In one embodiment, within each scanning raster 401 and 420, the scanning curves are arranged in an uneven fashion. As shown in FIG. 4, the curvature of the scanning rasters are denser towards the center than in the periphery to match the cone density drop with eccentricity of the retina. To illustrate this point, a border 410 is drawn in FIG. 4 to demonstrate the tiling provided between multiple scanning rasters 401 and 420. However, one skilled in the art will appreciate that line 410 depicting this border is conceptual and that no physical line exists. In one embodiment, the scanning raster may overlap slightly.

Although FIG. 4 shows two spiral rasters, additional numbers of raster may be used corresponding to the number of retinal light scanning engines 210. For example, three or more scanning rasters may be used by three or more retinal light scanning engines. In one example, rasters may be provided to correspond with different regions of the retina. For example, a raster may be provided for one or more or each of the foveal avascular zone 0.5 mm, the fovea 1.5 mm, the parafovea 1.5-2.5 mm, the perifovea 2.5-5.5, and the macula and beyond>5.5 mm.

FIG. 5 shows a side view of another example of a configuration of the retinal display system 500. The retinal display system 500 provides an increased total FOV over a system such as retinal display system 200 by tiling multiple raster patterns or scans to form a single image in the retina of a viewer. In this configuration, a retinal light scanning engine 210 is provided for each scanning raster. As shown in FIG. 5, the retinal display system 500 includes a digital image processing system 201, two retinal light scanning engines 210a and 210b, and an optical element 220. The digital image processing system 201 processes digital content corresponding to an image that is to be displayed by the retinal display system 500. The digital image processing system 201 provides information and control signals 223a and 223b corresponding to the image to the retinal light scanning engines 210a and 210b. The retinal light scanning engine 210a writes light 224a corresponding to a portion of the image to the fovea region 501 of the retina 255 of the eye 225 of the viewer. For example, the retinal light scanning engine 210a may use the spiral raster 401 to tile a portion of the image to fovea region 501. The retinal light scanning engine 210b writes light 224b corresponding to a portion of the image to the periphery region 510 of the retina 255 of the eye 225 of the viewer. For example, the retinal light scanning engine 210b may use the spiral raster 420 to tile the remaining portion of the image outside the fovea region 501.

As shown in FIG. 5, the tiling of multiple scanning rasters are provided by a retinal display system 500. Although FIG. 5 shows two retinal light scanning engines, additional retinal light scanning engines may be used. For example, three or more retinal light scanning engines may be provided to write content to different locations of the retina of a user according to a corresponding scanning raster. In this example, because multiple retinal light scanning engines are used to projecting digital content to different locations of the retina, the total FOV of the vision system 500 is increased and more digital content may be displayed. Again, for simplicity and conciseness of explanation only, one group or set of retinal light scanning engines 210a and 210b for one eye 225 are shown in FIG. 5. However, one skilled in the art will appreciate that a stereoscopic or binocular retinal display system 200 includes at least one two groups or sets of light scanning engines 210a and 210b for each eye 225 of the user, for example, as explained below with regard to FIG. 7B.

FIGS. 6A shows an example of the amplitude modulated control signals for the multiple scanning light engines 210a and 210b of the retinal scanning devices 235 of FIG. 5. FIG. 6B shows an example of the spiral raster patterns provided by the retinal scanning device for the control signals shown in FIG. 6A to write content to the retina. As shown in FIG. 6A, four control signals are provided. For example, control signals x_{Scanner 1} and y_{Scanner 1} for scanning light engine 210a and control signals x_{Scanner 2} and y_{Scanner 2} for scanning light engine 210b.

FIG. 7A shows a flow chart of an exemplary process 700 for controlling the retinal display system of FIG. 5.

In operation 701, the digital image processing system 201 (e.g., a GPU) generates the image control signals, timing, and image content information for a first tile (e.g., tile 1) corresponding to a portion of the image to be drawn on the fovea of the retina and a second tile (e.g., tile 2) corresponding to a portion of the image to be drawn on the periphery of the retina (e.g., outside the fovea region).

The control signals, timing, and image content information are provided to the retinal light scanning engines of each of two groups (e.g., 210a and 210b) assigned to tile 1 and tile 2 of the image to be displayed. For example, in operation 702, the control signals and image content information for tile 1 (e.g., power, frequency, and timing) are received by the light source 230 of the first scanning engine 210a, and in operation 705, the control signals (e.g., frequency, amplitude, and timing for each of the x and y axes of movement corresponding to the spiral raster of tile 1) are received by the scanning device 235 of the first scanning engine 210a. In addition, in operation 717, control information to tune the lens 240 of the first scanning engine 210a to a desired focal depth is provided in response to eye tracking information (if any).

Similarly, in operation 721, the control signals and image content information for tile 2 (e.g., power, frequency, and timing) are received by the light source 230 of the second scanning engine 210b, and in operation 725, the control signals (e.g., frequency, amplitude, and timing for each of the x and y axes of movement corresponding to the spiral raster of tile 2) are received by the scanning device 235 of the second scanning engine 210b. In addition, in operation 737, control information to tune the lens 240 of the second scanning engine 210b to a desired focal depth is provided in response to eye tracking information (if any).

Operations 710, 715, 730, and 735 are performed synchronously according to the timing provided with the control signals from the digital image processing system 201 to synchronously write the light corresponding to tiles 1 and 2 to the retina of a viewer.

In operation 710, the RGB laser source of the first scanning engine 210a generates a light beam of varying color and intensity of the first spot size corresponding to the content of the portion of the image corresponding to tile 1. In operation 715, synchronously with operation 710, the scanner of the first scanning engine 210a writes the light from the RGB laser according to the raster pattern associated with tile 1 and the timing information.

At substantially the same time, in operation 730, the RGB laser source of the second scanning engine 210b generates a light beam of varying color and intensity of the second spot size corresponding to the content of the portion of the image corresponding to tile 2. In operation 735, synchronously with operation 730, the scanner of the second scanning engine 210a writes the light from the RGB laser according to the raster pattern associated with tile 2 and the timing information.

In operations 740 and 741, light intended for the fovea corresponding to tile 1 and light intended for the periphery corresponding to tile 2 from the first and second retinal light scanning engines 210a and 210b are reflected by the optical element 220 to the retina of the viewer. In operation 745, the light corresponding to tiles 1 and 2 are combined as an image perceived by the viewer of the retinal display system.

FIG. 7B shows a flow chart of an exemplary stereoscopy process for controlling the retinal display system of FIG. 5. To create a 3D object for a viewer, a stereoscopy process 750 is used. In the process 750, two, 2D offset images are projected separately to the left and right eye of the viewer. The 2D images are then combined by the brain of viewer to give the viewer a perception of 3D depth. Therefore, for example, for 3D video or other content animation, each image frame for left & right eye needs to be synchronized. For example, the left eye image and right eye image are driven at the same frame rate, and the first scanning spots for both left and right eye images are shown at the same time. The process 750 illustrates one image processing flow for a stereoscopic system.

According to the process shown in FIG. 7B, the digital image processing system 201 (e.g., a GPU) generates the image control signals and image content information for the right and left eye of a viewer of the retinal display system 751. The image control signals and the image content information for the left eye are provided to one or more retinal light scanning engines 210 providing light to the left eye 755. Simultaneously or substantially simultaneously, the image control signals and the image content information for the right eye are provided to one or more retinal light scanning engines 210 providing light to the right eye 756. The one or more retinal light scanning engines 210 providing light to the left eye are synchronized with the one or more retinal light scanning engines 210 providing light to the right eye according to control signals. In operations 760 and 761, the corresponding devices (e.g., 230, 235, and 240) for the one or more retinal light scanning engines 210 assigned to each eye generate a 2D image for the left eye 780 and a 2D image for the right eye 781 by projecting light into the retinas of the viewer's eyes. The viewer's eye then combines and perceives the 2D images as a 3D image 785.

FIGS. 8A, 8B, 8C, 8D, and 8E show examples of a head mounted display with a retinal display system.

FIGS. 8A, 8B, 8C shows a perspective view, front view, and bottom view, respectively, of one example of an HMD 800. As shown the HMD includes a visor 801 attached to a housing 802, straps 803, and a mechanical adjuster 810 used to adjust the position and fit of the HMD to provide comfort and optimal viewing by a user of the HMD 800. The visor 801 may include one or more optical elements, such as an image combiner, that includes a shape and one or more reflective coatings that reflect an image from an image source 820, such as a retinal scanning engine 210, to the eyes of the user. In one example, the coating is partially reflective allowing light to pass through the visor to the viewer and thus create a synthetic image in the field of view of the user overlaid on the user's environment and provide an augmented reality user interface. The visor 801 can be made from a variety of materials, including, but not limited to, acrylic, polycarbonate, PMMA, plastic, glass, and/or the like and can be thermoformed, single diamond turned, injection molded, and/or the like to position the optical elements relative to an image source and eyes of the user and facilitate attachment to the housing of the HMD.

In one implementation, the visor 801 may include two optical elements, for example, image regions 805, 806 or clear apertures. In this example, the visor 801 also includes a nasal or bridge region, and two temporal regions. Each image region is aligned with the position 840 of one eye of a user (e.g., as shown in FIG. 8B) to reflect an image provided from the image source 820 to the eye of a user of the HMD. A bridge or nasal region is provided between the two image regions to connect the two regions 805 and 806. The image regions 805 and 806 mirror each other through the y-z plane that bisects the nasal rejoin. In one implementation, the temporal region extends to an outer edge of the image region wrapping around the eyes to the temple housing of the HMD to provide for peripheral vision and offer support of the optical elements such that the image regions 805 and 806 do not require support from a nose of a user wearing the HMD.

In one implementation, the housing may include a molded section to roughly conform to the forehead of a typical user and/or may be custom-fitted for a specific user or group of users. The housing may include various electrical components of the system, such as sensors 830, a display or projector, a processor, a power source, interfaces, a memory, and various inputs (e.g., buttons and controls) and outputs (e.g., speakers) and controls in addition to their various related connections and data communication paths. FIG. 8D shows an example of a HMD 800B in which the processing device 861 is implemented outside of the housing 802 and connected to components of the HMD using an interface (e.g. a wireless interface, such as Bluetooth or a wired connection, such as a USB wired connector). FIG. 8E shows an implementation in which the processing device is implemented inside of the housing 802.

The housing 802 positions one or more sensors 830 that detect the environment around the user. In one example, one or more depth sensors are positioned to detect objects in the user's field of vision. The housing also positions the visor 801 relative to the image source 820 and the user's eyes. In one example, the image source 820 may be implemented using two or more retinal light scanning engines as described herein. For example, the image source may provide at least one retinal light scanning engine 210 for each eye of the user. For example, if an optical element 805, 806 of the visor is provided for each eye of a user, one or more retinal light scanning engines 210 display may be positioned to write light to a corresponding optical element.

As shown in FIGS. 8D and 8E, one or more processing devices may implement applications or programs for implementing the processes as outlined above. In one example, the processing device includes an associated memory storing one or more applications implemented by the processing device that generate digital image data and control signals depicting one or more of graphics, a scene, a graphical user interface, a computer game, a movie, content from the Internet, such as web content accessed from the World Wide Web, among others, that are to be presented to a viewer of the wearable HMD. Examples of applications includes media players, mobile applications, browsers, video games, and graphic user interfaces, to name but a few. In addition, the applications or software may be used in conjunction with other system processes. For example, an unwarping process and a visual accommodation process for alignment and to compensate for distortion induced by an optical element 805, 806 of such as system may be included. An example of such a visual accommodation process is described in U.S. Non-provisional application Ser. No. 14/757,464 titled “APPARATUSES, METHODS AND SYSTEMS COUPLING VISUAL ACCOMMODATION AND VISUAL CONVERGENCE TO THE SAME PLANE AT ANY DEPTH OF AN OBJECT OF INTEREST” filed on Dec. 23, 2015, and the unwarping process is described in U.S. Provisional Application No. 62/275,776 titled “APPARATUSES, METHODS AND SYSTEMS RAY-BENDING: SUB-PIXEL-ACCURATE PRE-WARPING FOR A DISPLAY SYSTEM WITH ONE DISTORTING MIRROR” filed on Jan. 4, 2016, both of which are hereby incorporated by reference in their entirety for all purposes.

As described above, the techniques described herein for a wearable AR system can be implemented using digital electronic circuitry, or in computer hardware, firmware, software, or in combinations of them in conjunction with various combiner imager optics. The techniques can be implemented as a computer program product, i.e., a computer program tangibly embodied in a non-transitory information carrier or medium, for example, in a machine-readable storage device, in machine-readable storage medium, in a computer-readable storage device or, in computer-readable storage medium for execution by, or to control the operation of, data processing apparatus or processing device, for example, a programmable processor, a computer, or multiple computers. A computer program can be written in any form of programming language, including compiled or interpreted languages, and it can be deployed in any form, including as a stand-alone program or as a module, component, subroutine, or other unit suitable for use in the specific computing environment. A computer program can be deployed to be executed by one component or multiple components of the vision system.

The exemplary processes and others can be performed by one or more programmable processing devices or processors executing one or more computer programs to perform the functions of the techniques described above by operating on input digital data and generating a corresponding output. Method steps and techniques also can be implemented as, special purpose logic circuitry, e.g., an FPGA (field programmable gate array) or an ASIC (application-specific integrated circuit).

Processing devices or processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. The processing devices described herein may include one or more processors and/or cores. Generally, a processing device will also include, or be operatively coupled to receive data from or transfer data to, or both, one or more mass storage devices for storing data, such as, magnetic, magneto-optical disks, or optical disks. Non-transitory information carriers suitable for embodying computer program instructions and data include all forms of non-volatile memory, including by way of example semiconductor memory devices, such as, EPROM, EEPROM, and flash memory or solid state memory devices; magnetic disks, such as, internal hard disks or removable disks; magneto-optical disks; and CD-ROM and DVD-ROM disks. The processor and the memory can be supplemented by, or incorporated in special purpose logic circuitry.

The HMD may include various other components including various optical devices and frames or other structure for positioning or mounting the display or projection system on a user allowing a user to wear the vision system while providing a comfortable viewing experience for a user. The HMD may include one or more additional components, such as, for example, one or more power devices or connections to power devices to power various system components, one or more controllers/drivers for operating system components, one or more output devices (such as a speaker), one or more sensors for providing the system with information used to provide an augmented reality to the user of the system, one or more interfaces from communication with external output devices, one or more interfaces for communication with an external memory devices or processors, and one or more communications interfaces configured to send and receive data over various communications paths. In addition, one or more internal communication links or busses may be provided in order to connect the various components and allow reception, transmission, manipulation and storage of data and programs.

In order to address various issues and advance the art, the entirety of this application (including the Cover Page, Title, Headings, Detailed Description, Claims, Abstract, Figures, Appendices and/or otherwise) shows by way of illustration various embodiments in which the claimed inventions may be practiced. The advantages and features of the application are of a representative sample of embodiments only, and are not exhaustive and/or exclusive. They are presented only to assist in understanding and teach the claimed principles. It should be understood that they are not representative of all claimed inventions. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims.

1. A method for providing digital content in a virtual or augmented reality visual system, the method comprising:
controlling a light source to create a beam of light corresponding to points of an image; and
moving an optical scanner receiving the beam of light from the light source to perform a scanning pattern to direct the light towards the retina of a viewer of the visual system;
wherein the scanning pattern is synchronized over time with the points of the image provided by the beam to create a perception of the image by the viewer.

2. The method of claim 1, wherein the light source comprises one or more lasers.

3. The method of claim 1 wherein the scanning pattern is spiral raster having a smaller gap between the lines of the spiral in the center of the spiral raster.

4. The method of claim 3, wherein the optical scanner directs a higher resolution scanning of the beam of light at the fovea of the retina.

5. The method of claim 1 further comprising:
reflecting the beam directed from the scanner by an optical element towards the eye of the viewer.

6. The method of claim 1 further comprising:
adjusting the focus of the beam created by the light source to present the image at a particular depth of focus.

7. The method of claim 1 wherein the optical scanner comprises one or more microelectromechanical systems (MEMS) mirrors.

8. The method of claim 1, wherein the combined operations controlling and moving are performed for each eye of the user.

9. A method for providing digital content in a virtual or augmented reality visual system, the method comprising:
controlling a first light source to create a first beam of light corresponding to first points of an image;
controlling a second light source to create a second beam of light corresponding to second points of the image;
moving a first optical scanner receiving to the first beam light from the first light source according to a first scanning pattern to direct the light of the first beam towards the retina of a viewer of the visual system; and
moving a second optical scanner receiving to the second beam light from the second light source according to a second scanning pattern to direct the light of the second beam towards the retina of a viewer of the visual system;
wherein the first scanning pattern and the second scanning pattern are synchronized over time with the points of the image provided by the first and second beams to create a coherent perception of the image by the viewer.

10. The method of claim 9, wherein the first and second light sources comprise one or more lasers.

11. The method of claim 10, wherein the diameter of the beam created by the first light source is smaller than the diameter of the beam created by the second light source.

12. The method of claim 9 wherein the first scanning pattern is a first spiral raster directing the first beam of light towards the fovea region of the retina of the viewer, and the second scanning pattern is a second spiral raster directing the second beam of light towards a region outside of the fovea of the retina of the viewer.

13. The method of claim 12 wherein the gap between the spiral lines of the first raster is smaller the gap between the spiral lines of the second spiral raster.

14. The method of claim 12 wherein the first spiral raster and the second spiral raster partially overlap.

15. The method of claim 9 further comprising:
reflecting the first beam directed from the first scanner and the second beam directed from the second scanner by an optical element towards the eye of the viewer.

16. The method of claim 9 further comprising:
adjusting the focus of at least one of the first beam and the second beam to present the image at a particular depth of focus.

17. The method of claim 9 wherein the first scanner and the second scanner each comprise one or more microelectromechanical systems (MEMS) mirrors.

18. The method of claim 9, wherein the combined operations controlling the first and second light sources and moving the first and second optical scanner are performed for each eye of the user.

19. A retinal display system comprising:
at least one retinal light scanning engine, the retinal scanning engine comprising:
a light source configured to create a beam of light corresponding to points of an image; and
an optical scanner coupled to the light source and configured to receive the beam of light from the light source and perform a scanning pattern;
wherein the scanning pattern synchronizes movement of the optical scanner over time with the points of the image provided by the beam to direct light of the beam towards the retina of a viewer of the display system and creates a perception of the image by the viewer.

20. The display of claim 19 further comprising:
at least one processing device configured to execute instructions that cause the processing device to control the at least one retinal light scanning engine by providing control signals to the light source and the scanning pattern to the optical scanner.

21. The display of claim 19, wherein the light source comprises one or more lasers.

22. The display of claim 19 wherein the scanning pattern is spiral raster having a smaller gap between the line of the spiral in the center of the spiral raster and the optical scanner directs a higher resolution scanning of the beam of light at the fovea of the retina.

23. The display of claim 19 further comprising:
an optical element corresponding to the at least one retinal light scanning engine and configured relative to the optical scanner and eyes of the viewer of the system to reflect the beam directed from the scanner by towards the eye of the viewer.

24. The display of claim 19, wherein the at least one retinal light scanning engine further comprising:
an adjustable focal element positioned between the light source and the scanner that is configured to focus of the beam created by the light source to present the image at a particular depth of focus.

25. The display of claim 19 wherein the scanner comprises one or more microelectromechanical systems (MEMS) mirrors.

26. The display of claim 19 further comprising at least one other retinal light scanning engine wherein the at least one retinal light scanning engine and the at least one other retinal light scanning engine are configured to create separate beams of light for each eye of a viewer of the display.

27. The display of claim 19 further comprising at least one other retinal light scanning engine wherein the at least one other retinal light scanning engine comprises:
at least one other light source configured to create another beam of light corresponding to points of the image; and
at least one other optical scanner optically coupled to the at least one other light source and configured to receive the at least one other beam light from the at least one other light source and move according to another scanning pattern;
wherein the scanning pattern synchronizes movement of the optical scanner over time with the points of the image provided by the beam to direct light of the beam towards the fovea of the retina of a viewer of the display system, and the other scanning pattern synchronizes movement of the other optical scanner over time with the points of the image provided by the other beam to direct light of the other beam towards a region of retina outside the fovea of a viewer of the display system to create a coherent perception of the image by the viewer.

28. The display of claim 27, wherein the at least one other light source comprise one or more lasers.

29. The display of claim 28, wherein the diameter of the beam created by the light source is smaller than the diameter of the beam created by the at least one other light source.

30. The display of claim 27 wherein the scanning pattern and the at least one other scanning pattern are a first spiral and a second spiral raster, and the gap between the spiral line of the first spiral is greater than the gap between the spiral line of the second spiral raster.

31. The display of claim 27 wherein the scanning pattern and the at least one other scanning pattern are a first spiral and a second spiral raster, and the first spiral raster and the second spiral raster partially overlap.
